(19) United States
(12) Patent Application Publication
(10) Pub. No.: US 2007/0006706 A1
(43) Pub. Date: Jan. 11, 2007

(54) Auxiliary device for cutting in band saw and usage of the same

(76) Inventors: Shunsuke Watanabe, Shizuoka-shi (JP); Masaru Yoshida, Shizuoka-shi (JP)

Correspondence Address: JACOBSON HOLMAN PLLC, 400 SEVENTH STREET N.W., SUITE 600, WASHINGTON, DC, 20004, US

(21) Appl. No.: 11/482,750

(22) Filed: Jul. 10, 2006

(30) Foreign Application Priority Data
Jul. 8, 2005 (JP) 2005-200803

(51) Int. Cl. B23D 55/00

(52) U.S. Cl. 83/788; 83/820

(57) ABSTRACT

Influence of drift of a metal band in a band saw is corrected, so that an intended shape can be easily cut out. In a band saw of cutting a workpiece using a flexible metal band, an auxiliary device used in cutting the workpiece includes a body that is disposed on a surface of a work table of the band saw, and has a passage portion of the metal band at one end; a correction mechanism interposed between the body and the work table to shift a direction of the body in a direction deviated from a virtual cutting line by the metal band to correct deviation of a cutting direction by the metal band; and a clamp unit for clamping the body to the work table; wherein part of the body having a shifted direction is parallel to a direction of feeding the workpiece to the metal band.

### BACKGROUND OF THE INVENTION

1. Field of the Invention

The present invention relates to an auxiliary device used in cutting a workpiece in a band saw of cutting a workpiece using a flexible metal band, and usage of the device.

2. Description of Related Art

In operation using the band saw, drift of the flexible metal band, commonly known as blade, needs to be considered. The blade drift is a tendency that even if a workpiece is straightly fed to the blade, the workpiece is not straightly cut and gradually deviated right or left, which is regarded to be caused by bending of the blade and is known to occur more significantly in a blade having small width. When cutting operation is performed while leaving the blade drift, for example, since a workpiece can not be cut according to a marking-off line drawn on the workpiece, each operator has performed the operation while correcting the blade drift to be canceled.

Moreover, influence of the blade drift appears not only in straight cutting, but also in circular cutting. And in this case, the influence appears as a difficulty that cutting end is offset with respect to cutting start, or do not correspond thereto. In a typical example of a jig in the related art called circle cutter jig, first a center point and a circle to be cut out are drawn on a workpiece, then cutting of the workpiece is started toward the circumference of the drawn circle, and then the cutting is suspended at a tangent point, and a needle for supporting the center is set, and then the cutting is restarted with the needle as a center, and finally circle cutting operation is completed. Therefore, workability is bad; in addition, since the needle is attached to a place outside a work table, it can not be used in operation with the work table being inclined.

On the other hand, in a band saw in JP-A-2001-18117, a slider having a shaft clamp is attached to a long arm of an arm formed in a J-shape, and a clamping device to a cutting table is attached to a short arm of the same arm, and the slider is fixed with a peak of a cutter portion of a saw blade being corresponding to an intersection between a radius and tangent of a circle, so that accurate cutting of the circle is realized. In the case of such an invention, positions of the center needle and the peak of the cutter portion of the saw blade are forcibly kept constant, and if influence of the drift is not considered, such a band saw is considered to be able to cut a workpiece into an accurate circle. However, when drift occurs, since the band saw can not meet the drift, it can not cut out the accurate circle, or undesirably applies excessive force to a metal band to cancel the drift.

### SUMMARY OF THE INVENTION

It is desirable to correct influence of the drift of the metal band in the band saw, so that an intended shape can be easily cut out. Furthermore, it is desirable that particularly in circle cutting operation, a workpiece can be guided to a tangent point of a circle by rotation of the device of an embodiment of the invention rather than freehand. Still furthermore, it is desirable that a truncated-cone shape can be easily cut out by inclining a workpiece, in addition, it is desirable that a container can be formed by piling materials cut out from one sheet material.

In an embodiment of the invention, in a band saw of cutting a workpiece using a flexible metal band, an auxiliary device used in cutting the workpiece includes a body that is disposed on a surface of a work table of the band saw, and has a passage portion of the metal band at one end; a correction mechanism interposed between the body and the work table to shift a direction of the body in a direction deviated from a virtual cutting line by the metal band to correct deviation of a cutting direction by the metal band; and a unit for clamping the body to the work table; wherein part of the body having a shifted direction is parallel to a direction of feeding the workpiece to the metal band. Moreover, a central axis positioning section can be provided in order to circularly cut the workpiece, the section being situated between the other end of the body and the passage portion, and having an upward pin to be thrust into the workpiece to be a central axis.

A band saw directed by the embodiment of the invention processes a workpiece using a flexible metal band as the name of band saw itself, and mainly wood is processed as the workpiece. As a basic configuration, the band saw is supposed to have a pair of wheels in upper and lower sides, around which a ring-like flexible metal band is rode, and have a work table, so called table, set between the wheels, wherein the table is set in a manner of passing the flexible metal band through a portion of a cutting nose plate of the table, and the workpiece is moved on the work table for an intended cutting operation.

The auxiliary device of the embodiment of the invention has the body used on the work table. The body has the passage portion of the metal band at one end. The passage portion may be a portion machined along an edge of the one end of the body, or a slit-like portion machined in a manner of cutting into the inside of the one end of the body. An example described later shows the slit-like passage portion.

The central axis positioning section for circularly cutting the workpiece may be in a configuration that a position of the pin as the central axis is fixed, however, the position of the pin is desirably movable or selectable between one end side and the other end side of the body, so that a space between the upward pin provided in the central axis positioning section and the passage portion of the metal band, that is, a radius of a circle to be cut can be changed larger or smaller. The central axis positioning section can be in a configuration where a long groove extending from a position near the one end of the body to a position near the other end, a sliding member slidably engaged with the long groove, and a clamping unit of clamping the sliding member at any position are combined, and the upward pin is provided on the sliding member.

To correct the deviation of the cutting direction by the metal band, that is, the drift of the blade, the embodiment of the invention has the correction mechanism interposed between the body and the work table to shift the direction of the body in the direction deviated from the virtual cutting line by the metal band to allow a workpiece feed direct on to correspond to the deviated direction. In the embodiment of the invention, the virtual cutting line is a cutting line when a workpiece is assumed to be fed straightly without drift and influence of a structure of the workpiece, or corresponds to a cutting direction of the workpiece in the case of cutting a workpiece without having a stria using a flexible metal band without having bending.

To correct the deviation in the cutting direction by the metal band, the deviation having been detected through test cutting, the correction mechanism is configured to have an arm rotatably pivoted at one end in the lower portion of the body, and have a positioning strip rotatably pivoted at the other end of the arm, wherein the positioning strip is contacted to an end of the work table of the band saw to shift the direction of the body on the work table in order to the drift. In this case, since the correction mechanism has an arm pivoting portion, rotational motion of the body is enabled, consequently drift is easily corrected. After a correction level of drift has been determined, a workpiece can be cut according to a marking-off line. In particular, a start point of cutting on a circumference can be accurately guided to the metal band in circle cutting operation.

When conical rings or truncated-cone pieces are sequentially cut out from a sheet material using the auxiliary device of the embodiment of the invention, inclination of the table is changed such that a slope of the inside of a ring having the largest diameter is more gentle than a slope of the outside of the ring, thereby an upper outer diameter R1 of the outermost ring is made largest, and a lower outer diameter R2 of the outermost ring approximately corresponds to an upper outer diameter R3 of a ring having a second largest diameter, and furthermore a lower outer diameter R4 of the ring having the second largest diameter approximately corresponds to an upper outer diameter R5 of a ring having a third largest diameter, and subsequent rings are in a similar relationship to each together; thereby a plurality of conical rings or truncated-cone pieces can be cut out from one sheet material, and those from the ring having the largest diameter to the truncated-cone piece having the smallest diameter are vertically piled in order of size, so that a container-like object can be formed.

Since the embodiment of the invention is configured and functions as above, it exhibits an advantage that influence due to deviation of the metal band in the band saw is absorbed, thereby an intended shape can be easily cut out. Moreover, according to the embodiment of the invention, a direction and a level of the drift are previously understood, and the body is set on the work table correspondingly to the deviation, therefore in the circle cutting operation, the blade drift can be adjusted by rotating the device to a start point on a tangent of a circle, and furthermore since the upward pin supports a workpiece from below, such operation that a truncated-cone piece is cut out with the workpiece being inclined can be easily performed. Furthermore, since a container can be formed from one sheet material, efficient use of resources can be achieved.

### BRIEF DESCRIPTION OF THE DRAWINGS

FIG. 1 is a perspective view showing a condition where an auxiliary device for cutting according to the embodiment of the invention is attached to a band saw;

FIG. 2 is a plane view showing an example of the device;

FIG. 3 is a cross section view showing a condition of attaching the device of the embodiment of the invention to a work table;

FIG. 4 is a partial perspective view of the device of the embodiment of the invention;

FIG. 5 is a partial plane view showing an example of a correction mechanism and a clamp unit;

FIG. 6 is a plane view showing a condition of drift correction;

FIG. 7 is a plane view of a condition when circle cutting operation is started;

FIG. 8 is a plane view of a condition when the circle cutting operation is started into circle cutting;

FIG. 9 is a plane view of a condition during the circle cutting operation;

FIG. 10 is a plane view of a condition when the circle cutting has been completed;

FIG. 11 is a cross section view during the circle cutting collectively showing a perspective view of a cutout circular piece;

FIG. 12 is a back illustration drawing of a condition that the work table is inclined;

FIG. 13 is a cross section view during conical cutting collectively showing a perspective view of a cutout conical piece;

FIGS. 14A to 14B are cross section views showing a conical cutout piece and a product example using the piece; and

FIGS. 15A to 15B are views showing conical rings and product example 2 using conical cutout pieces as usage of the auxiliary device for cutting in the band saw according to the embodiment of the invention, wherein FIG. 15A is a cross section view of a completed container, and FIG. 15B is a cross section view showing an oblique cutting method respectively.

### DESCRIPTION OF THE PREFERRED EMBODIMENT

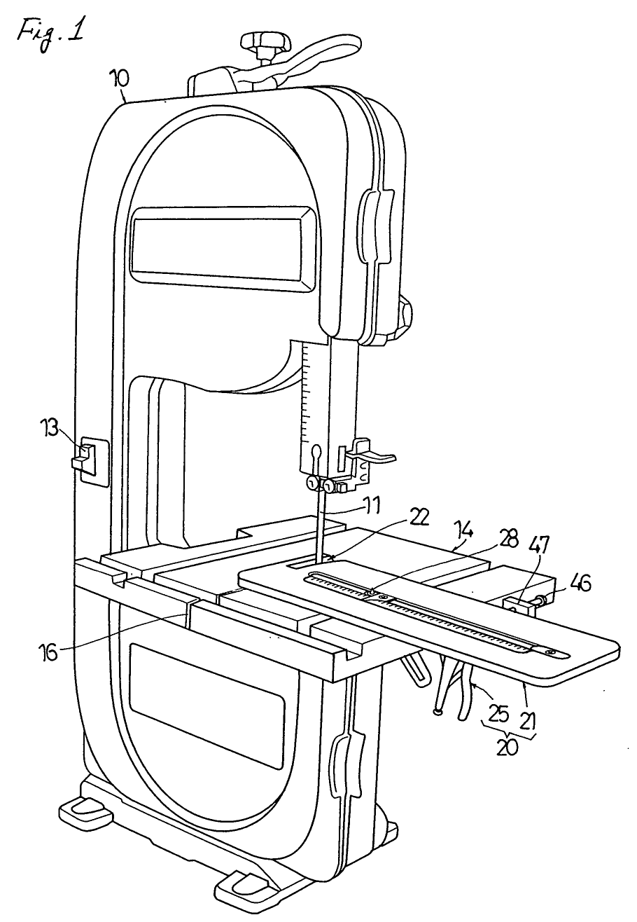

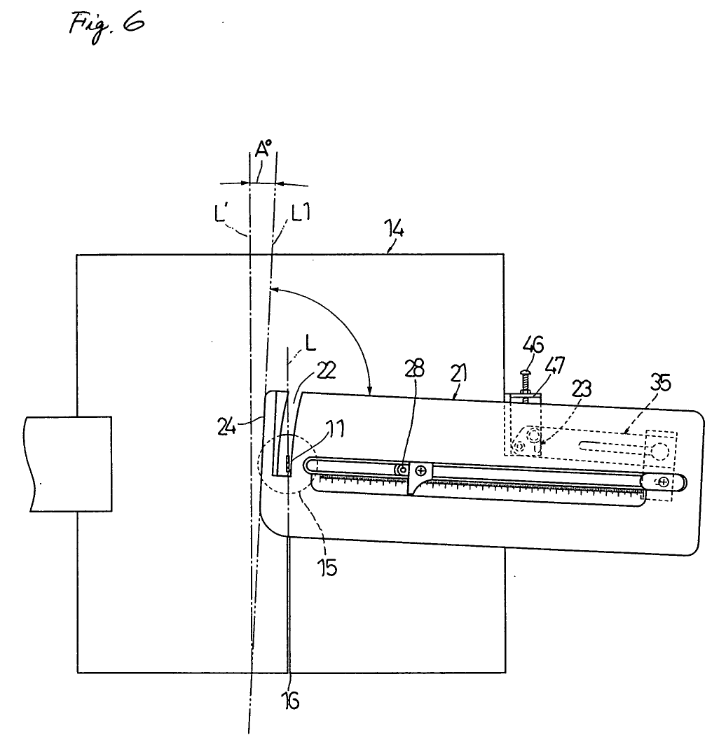

Hereinafter, the embodiment of the invention is described in detail with reference to an embodiment as shown in drawings. FIG. 1 is an overall view of a band saw 10 directed by the embodiment of the invention, wherein a flexible steel band 11 is rode around an upper wheel and a lower wheel arranged vertically in an inside of a covering, and driven by a motor 12 (see FIG. 12). In FIG. 1, a reference 13 indicates an on-off switch for driving motor, and a reference 14 indicates a work table or a table, and an operator stands in the left in FIG. 1 facing slightly right such that a switch 13 is left, a device 20 of the embodiment is right, and the steel band 11 is front. The steel band 11 is situated in a cutting-nose plate attaching portion 15 of the work table (see FIG. 6), and a groove 16 is communicated from this side of the work table 14 to the attaching portion 15.

The auxiliary device for cutting 20 of the embodiment of the invention is used while being disposed on a surface of the work table, and has a body 21 having a passage portion 22 of the steel band 11 at one end, a correction mechanism 23 for correcting a direction of the body 21 correspondingly to a direction deviated from a virtual cutting line by the steel band 11, and a clamp unit 25 for clamping the body 21 to the work table 14. The illustrated body 21 has an elongated form where one end 24 reaches the cutting-nose plate attaching portion 15 in the center of the work table, and in that state, the other end protrudes from an edge of the work table 14.

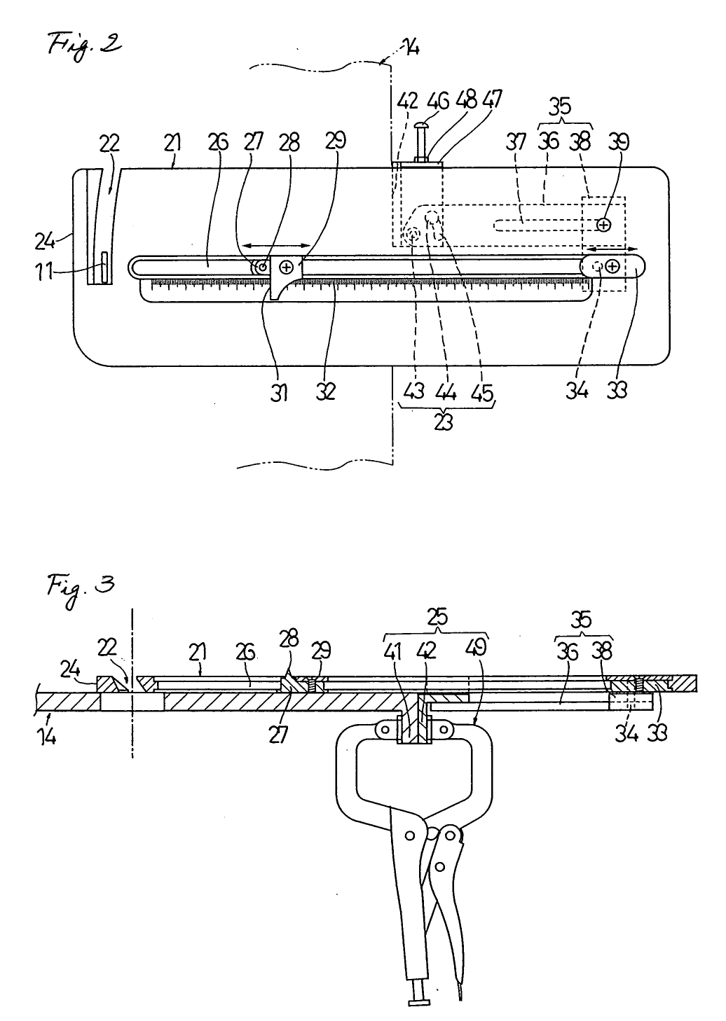

The passage portion 22 is formed at a side of one end of the rectangular body 21 approximately parallel to the one end from a long side in a front with respect to a workpiece feed direction, and formed in an arcuate slit shape for circle cutting (see FIG. 2). Furthermore, in the case of an example of the figure, a groove face of the slit forming the passage portion 22 is formed with a wall face inclined to the lower right to fit a slope of the work table 14 that can be inclined downward to the right of the band saw 10, rather than perpendicularly to a plate surface of the body 21, in order to prevent contact with the steel band 11 (see FIG. 3).

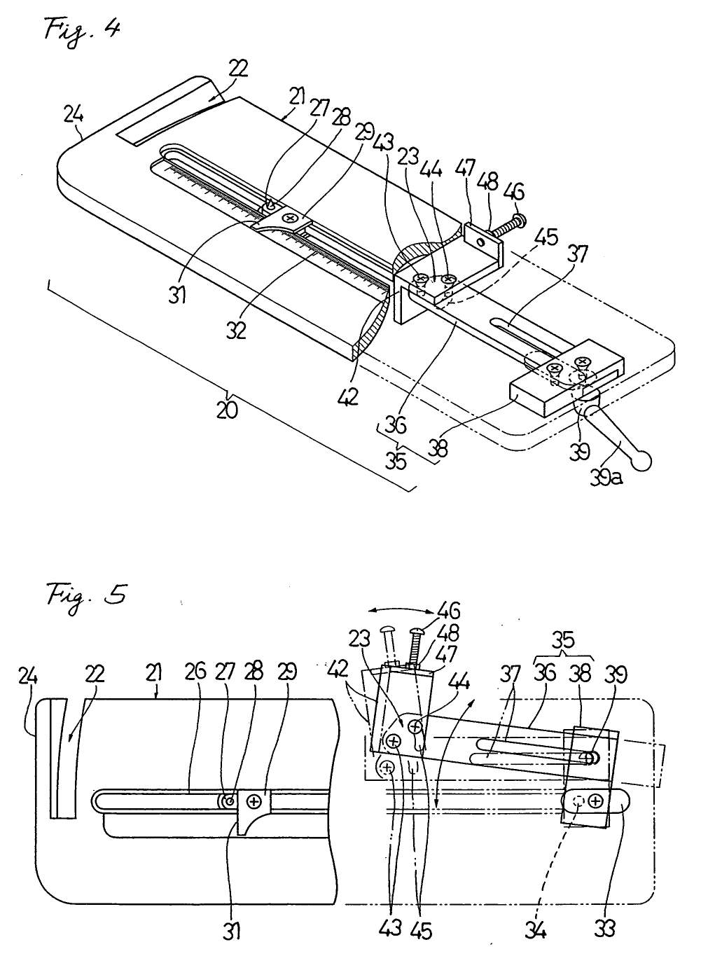

The body 21 has a long groove 26 between the passage portion at one end side and the other end, and a sliding member 27 slidably engaged with the long groove 26 has an upward pin 28 to be thrust into the workpiece to be a central axis. The sliding member 27 is engaged with the long groove 26 from below, and a screw of an upper member 29 engaged with the long groove 26 from above conversely is fastened or loosened, thereby the pin 28 can be clamped at any position. Those from the long groove to the stator configure the central axis positioning section. The upper member 29 has a pointer 31, and is configured such that a radius of a circle that may be cut out can be read on a scale 32 provided along the long groove 26 to indicate a distance from the steel band 11 at the passage position 22 (see FIG. 4). A diameter can be also indicated depending on a way of providing the scale and a way of indication.

Furthermore, on the body 21, the correction mechanism 23 and an attaching portion as a part of the clamp unit 25 are provided by using the long groove 26. First, an attaching member 33 is attached by screwing at the other end side of the body, and an arm 35 is attached to a lower portion of the attaching member 33 at one end rotatably by a spindle 34. While the arm 35 includes a single member, the illustrated one includes two members assembled in an L-shape. In addition, one member 36 has an adjustment groove 37 in a longitudinal direction, so that length of the one member 36 can be adjusted by fastening or loosening of a fitting screw 39 inserted through the other member 38. A reference 39a indicates a screw operation lever.

On the other end of the one member 36 at a side opposite to a side of the arm 35, a positioning strip 42 is rotatably pivoted in manner of contacting to an end 41 of the work table 14 of the band saw 10. A reference 43 indicates a rotation center axis of the positioning strip 42, and a reference 44 indicates a setscrew for setting the positioning strip 42 to the arm 35 through an arcuate guide groove 45. The positioning strip 42 has a stopper screw 46 contactable to the long side of the body 21. The illustrated stopper screw 46 is screwed into a rising strip 47 that is perpendicular to the positioning strip 42 and rises to be surface-contactable to the long side of the body 21. The body 21 is stopped at the rising strip 47, and after adjusting the drift, since the rising strip 47 and the long side of the body 21 are not in a surface contact condition, the rising strip is provided as supplement to stabilize a stopper function. A reference 48 indicates an anti-loosening nut (see FIGS. 4 and 5).

The positioning strip 42 is surface-contactable to a surface of the end 41 of the work table 14 (see FIG. 3), and in such a surface contact condition, it is pressed and clamped by a restraint tool 49 configuring the clamp unit 25. The illustrated restraint tool 49 is a tool known as so-called clamp, and is preferable for the embodiment of the invention because it can be freely attached and removed. However, the restraint tool 49 is not limited to the so-called clamp, and for example, vices can be used as the restraint tool.

Usage of the auxiliary device for cutting 20 of the embodiment of the invention configured in this way is described hereinafter. In FIG. 6, when a workpiece W is advanced straightly in a direction of a straight line L (virtual cutting line) corresponding to a width direction of the steel band 11 and cut, in the case that a cutting line of the workpiece is deviated right by an angle A from a direction of a straight line L′ parallel to the virtual cutting line L, since such a deviation level corresponds to a drift level of the steel band 11, a line (drift line) L1 in a direction of the cutting line is drawn on the surface of the work table. The correction mechanism 23 and the clamp unit 25 are adjusted such that the one end 24 of the body 21 is aligned with the drift line L1, and in an adjusted state, respective portions are restrained to prevent the body 21 from being moved. However, the spindle 34 is not restrained, thereby an adjusting condition of the correction mechanism 23 is maintained, and consequently the body 21 can be freely withdrawn from a position on the work table, and returned to the original adjusting state.

In a condition of FIG. 6, the one end 24 of the body 21 corresponds to drift of the steel band 11. Thus, while keeping the angle A, the body 21 is moved such that the one end 24 is situated in the right of the steel band 11 in FIG. 6 and clamped thereat, then when a side of a workpiece is contacted to the one end 24 of the body 21, and advanced with the end 24 as a guide, the workpiece can be cut straightly. That is, since the device 20 of the embodiment of the invention corrects the drift, the workpiece is cut straightly.

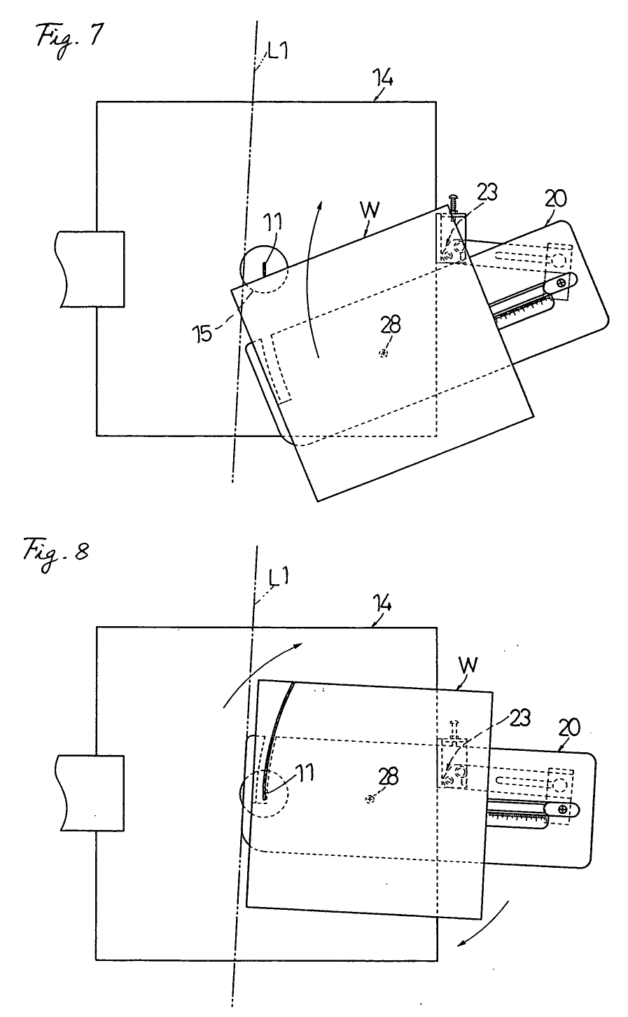

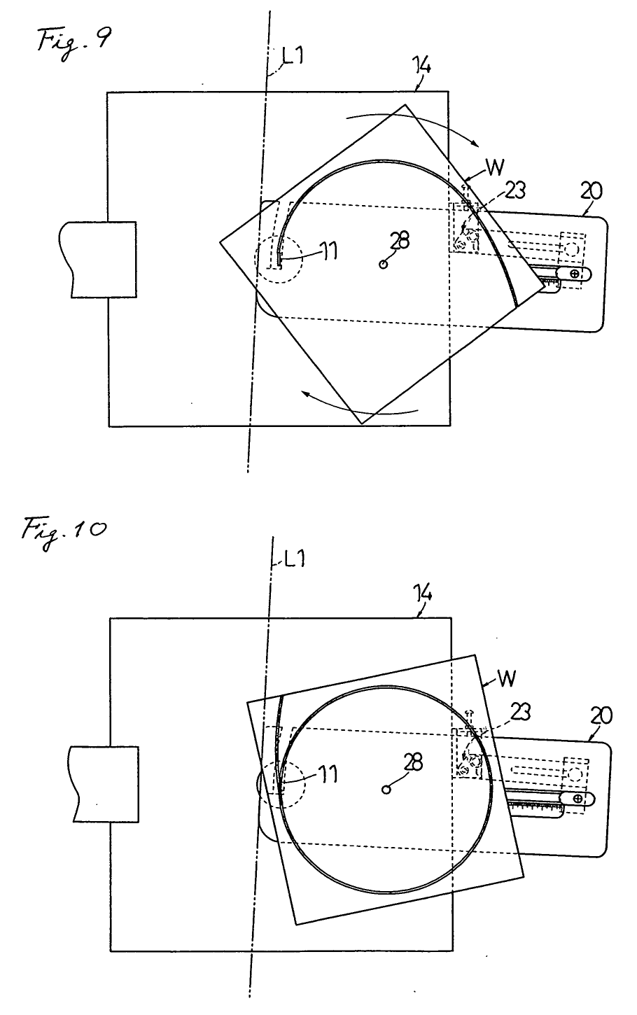

Moreover, using the above correction as it is, circle cutting of a workpiece can be carried out. FIGS. 7 to 10 show an example of the circle cutting. When the workpiece W is circularly cut, the body is withdrawn from the steel band 11, then the sliding member 27 is moved to a central position of a circle having an intended radius, and then the pin 28 is thrust into a center of the workpiece W (FIG. 7), and in this condition, the body 21 is rotated with the spindle 34 as a center to cut the workpiece W by the steel band 11 until a state of FIG. 8 is given. A straight line dropped from a tip of the pin 28 to an edge of the steel band 11 needs to be perpendicular to the drift line L1. Next, the workpiece W is rotated with the pin 28 as a center to start the circle cutting (FIG. 8). At that time, according to the embodiment of the invention, the edge is naturally contacted to a circumference in a tangent direction, consequently the circle cutting is carried out. During this, the workpiece W can be merely rotated (FIG. 9). In the end of the circle cutting, a cutting line is connected to the circumference at cutting start without any offset (FIG. 10), consequently a round shape is cut out (see FIG. 11).

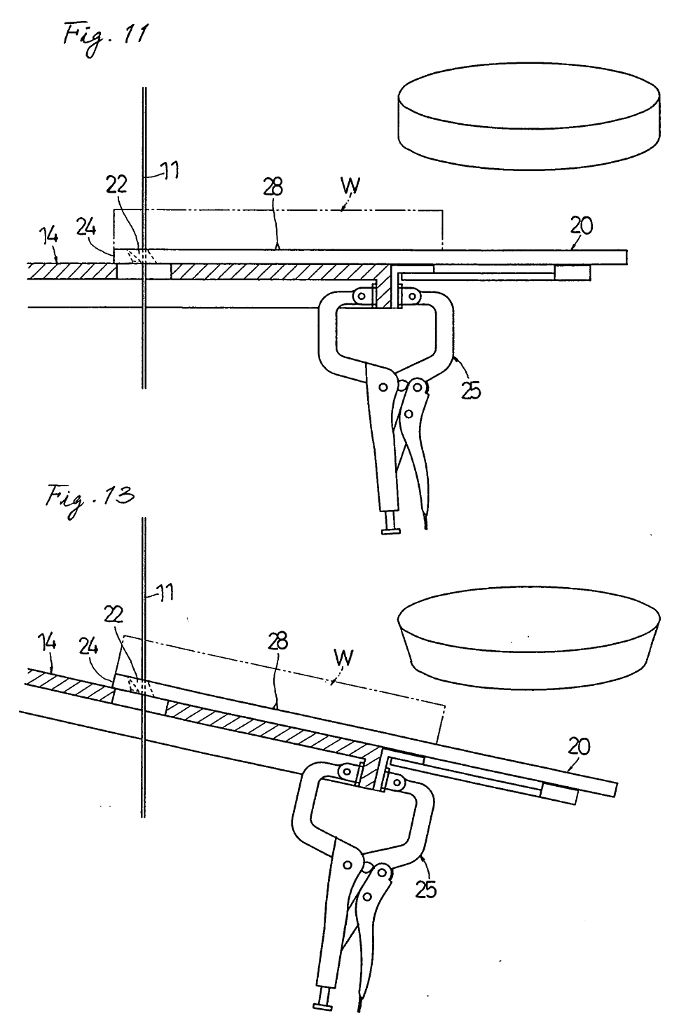

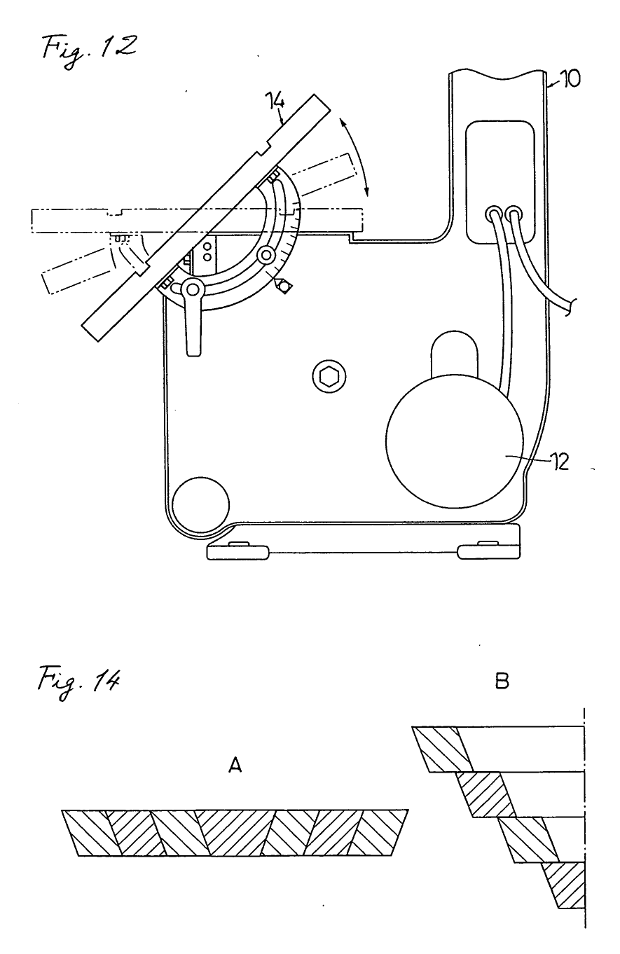

Since the auxiliary device for cutting 20 of the embodiment of the invention has the upward pin 28 disposed on the work table 14, cutting operation is not obstructed, and therefore operation that a circular object is cut out with the work table 14 being inclined to a level can be performed. FIG. 12 shows the work table 14 being inclined, and FIG. 13 shows cutting operation of a workpiece at an inclined condition, and a truncated-cone object obtained as a result of the operation. Since a truncated-cone shape can be cut out, a number of ring-like members of which the outer surfaces have conical curves can be cut out, and as shown in FIG. 14A, since an upper diameter of the conical ring is typically larger than a lower diameter of an outer ring, an inner ring is piled under an outer ring and joined thereto, thereby a container-like object can be easily produced (see FIG. 14B). In this way, an approximate conical container-like object can be produced, which is a particular and significant feature of the auxiliary device for cutting 20 of the embodiment of the invention.

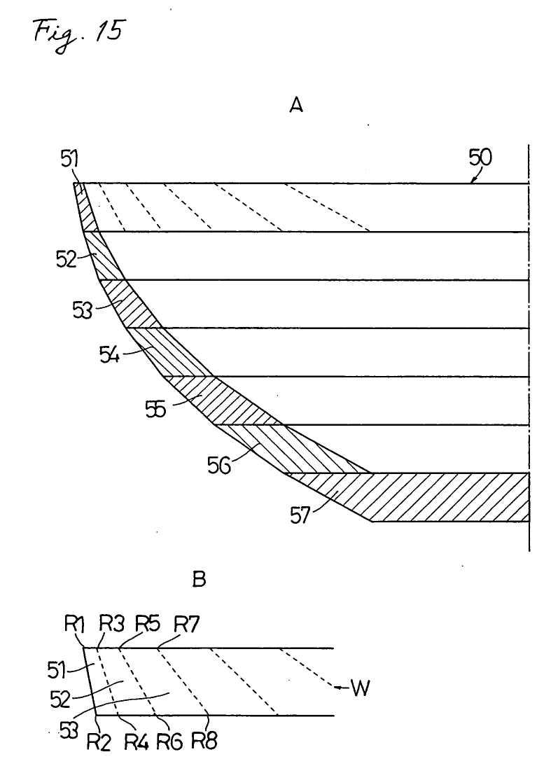

In usage of the auxiliary device for cutting 20 of the embodiment of the invention, a ball-like container 50 can be formed from one sheet material, which can be given as a feature. Therefore, an example is described with reference to FIG. 15. FIG. 15 shows an example that when conical rings are sequentially cut out from one sheet material W as above, slopes of an outer side face and the inside of a first ring 51 are made different from each other to be gradually gentle, such that an upper outer diameter R1 of the first ring 51 is a largest diameter, and a lower outer diameter R2 of the ring 51 corresponds to an upper outer diameter R3 of a second ring 52, and a lower outer diameter R4 of the second ring 52 corresponds to an upper outer diameter R5 of a third ring 53, and subsequent rings are in a similar relationship to each together. Inclination of the work table 14 is adjusted such that the inclination is most gentle when the outside of the first ring is cut out, and becomes steep stepwise with sequential change of rings to be cut, that is, second ring 52, third ring 53 and the like. By using the auxiliary device for cutting 20 of the embodiment of the invention, adjustment operation of the inclination as above can be easily carried out.

It is shown from the above that according to the usage of the device 20 of the embodiment of the invention, the adjustment operation can be carried out by changing an inclination angle and a radius every time when the circle cutting operation has been finished, which clearly shows the capability of the device 20 of the embodiment of the invention. Moreover, since the usage of wood as above is enabled and thereby a flat plate can be used to be formed into a container without any surplus, efficient use of resources can be achieved. While the ring obtained by the embodiment of the invention is partially cut because cutting operation is shifted from a circle having a large diameter to a circle having a small diameter, it is common to all band saws. The auxiliary device 20 for cutting of the embodiment of the invention can be used with being attached to approximately all band saws on the market.

What is claimed is:

1. An auxiliary device used in cutting a workpiece in a band saw of cutting the workpiece using a flexible metal band, the device comprising:
a body that is disposed on a surface of a work table of the band saw, and has a passage portion of the metal band at one end,
a correction mechanism interposed between the body and the work table to shift a direction of the body in a direction deviated from a virtual cutting line by the metal band to correct deviation of a cutting direction by the metal band, and
a unit for clamping the body to the work table;
wherein part of the body having a shifted direction is parallel to a direction of feeding the workpiece to the metal band.

2. The auxiliary device for cutting in the band saw according to claim 1:
wherein a central axis positioning section is provided in order to circularly cut the workpiece, the section being situated between the other end of the body and the passage portion, and having an upward pin to be thrust into the workpiece to be a central axis.

3. The auxiliary device for cutting in the band saw according to claim 1:
wherein the correction mechanism is configured to have an arm rotatably pivoted at one end in a lower portion of the body, and have a positioning strip rotatably pivoted at the other end of the arm, wherein the positioning strip is contacted to an end of the work table of the band saw to shift the direction of the body on the work table in order to correct drift.

4. The auxiliary device for cutting in the band saw according to claim 1:
wherein a central axis positioning section is in a configuration where the position of the pin is desirably movable or selectable between one end side and the other end side of the body, so that a space between the upward pin provided in the central axis positioning section and the passage portion of the metal band, or a radius of a circle to be cut can be changed larger or smaller.

5. Usage of an auxiliary device for cutting in a band saw:
wherein when conical rings or truncated-cone pieces are sequentially cut out from a sheet material, inclination of a work table is changed such that;
a slope of the inside of a ring having the largest diameter is more gentle than a slope of the outside of the ring, thereby an upper outer diameter R1 of the outermost ring is made largest, and a lower outer diameter R2 of the outermost ring approximately corresponds to an upper outer diameter R3 of a ring having a second largest diameter, and furthermore a lower outer diameter R4 of the ring having the second largest diameter approximately corresponds to an upper outer diameter R5 of a ring having a third largest diameter, and subsequent rings are in a similar relationship to each together; thereby a plurality of conical rings or truncated-cone pieces are cut out from one sheet material, and those from the ring having the largest diameter to a truncated-cone piece having the smallest diameter are vertically piled in order of size, so that a container-like object is formed.
